(19) United States
(12) Patent Application Publication
(10) Pub. No.: US 2002/0131592 A1
(43) Pub. Date: Sep. 19, 2002

(54) Entropy sources for encryption key generation

(76) Inventor: Harris Hinnant, Seattle, WA (US)

Correspondence Address: STOEL RIVES LLP, 900 SW FIFTH AVENUE, SUITE 2600, PORTLAND, OR, 97204, US

(21) Appl. No.: 09/809,774

(22) Filed: Mar. 16, 2001

(51) Int. Cl. H04L 9/00

(52) U.S. Cl. 380/46; 380/262; 380/270

(57) ABSTRACT

Inertial measurement units are subject to drift and noise characteristics that are normally distributed. While that drift and noise is problematic for inertial navigation, it is ideal for encryption key generation. The measurement values from an inertial measurement unit are random on several levels and can be used to effectively seed a pseudo random number generator for encryption key generation.

### RELATED APPLICATIONS

None

### TECHNICAL FIELD

The present invention relates to a method and apparatus for generating random numbers for use in secure communication. Specifically, the invention provides for using selected measurement values output from an inertial measurement unit (IMU) to seed a pseudo random number generator (PRNG). The PRNG then produces a string of numbers that can be used in conjunction with various encryption protocols for encryption key generation.

BACKGROUND OF THE INVENTION

Encryption is the process of converting plaintext into ciphertext, so that only the intended recipient, or recipients, can decipher the ciphertext to view the contents of the plaintext message. The sender encrypts a plaintext message prior to sending it and the recipient then decrypts the message upon receipt. Two basic types of encryption are currently in use: public key encryption and private key encryption. The two types of encryption can be used either alone or in combination with each other.

Public key encryption uses an asymmetric key, meaning a first key is used to encrypt the message while a different second key must be used to decrypt the message. A private key is kept secret such that only the key owner has access to it. A public key, on the other hand, is freely distributed. A message encrypted with the private key can be decrypted by anyone with access to the public key. This allows message recipients to verify the authenticity of the encrypted message because it could only have been created with the secure private key. Similarly, a message encrypted with the public key may only be decrypted with the private key. This ensures the privacy of messages because only the intended recipient, the owner of the private key, will be able to decrypt the message. The two keys are mathematically related to each other such that it is possible to derive the private key from knowledge of the specific encryption algorithm used and the public key, but typically the key length is sufficiently large so that it is not practical to spend the time and energy to derive the private key under most circumstances. The key length should also be large enough to ensure that the quickest attack for deciphering an encrypted message is an exhaustive key search (or brute force attack), given current technology and cryptanalysis techniques. Due to the complex relationship between the public and private keys and the consequent calculations necessary for encryption and decryption, this type of encryption typically requires more processing power and is slower than most private key encryption.

Private key encryption, on the other hand, uses a symmetric key, meaning that the key used to encrypt the message is the same key used to decrypt the message. The overall security of a private key encryption system depends on a variety of factors, including the strength of the key, proper key management, and secure key exchange. As with public key encryption, the key length should be large enough to ensure that the quickest attack for deciphering an encrypted message is an exhaustive key search (or brute force attack), given current technology and cryptanalysis techniques. The most secure method of key exchange is hand delivery between the parties; however, this is often impractical. Key exchange can also occur over the same communication link on which the encrypted transmission will be carried using publicly known protocols, but this kind of exchange is vulnerable to a middleman attack. When a middleman attack is successfully accomplished, it appears to both the sending and the receiving parties as though a private key was successfully exchanged and the two are engaging in secure communication. All the while, the middleman is monitoring, or possibly altering, the message contents sent by both parties.

Private key exchange can also be accomplished using public key encryption. In that scenario the first party encrypts the message to be transmitted using a symmetric key. The first party then encrypts the symmetric key using the second party's (the intended recipient's) asymmetric public key. The message, encrypted with the symmetric key, and the symmetric key, encrypted with the second party's asymmetric public key, are then transmitted together to the second party (the intended recipient). The second party then decrypts the symmetric key, using their asymmetric private key, and uses the symmetric key to decrypt the message.

The security of both above-referenced types of encryption depends, in part, on generating relatively strong encryption keys. Key generation can be effectively accomplished in two ways. First, a naturally random data source may be used to generate truly random numbers that are used in conjunction with various encryption protocols to generate encryption keys. Second, mathematical algorithms may be used to generate pseudo random numbers that are used in conjunction with various encryption protocols to generate encryption keys. These mathematical algorithms for generating pseudo random numbers are called PRNGs. While truly random numbers are ideal, they are not always practical. As a consequence, most encryption systems depend, in part, on their PRNG associated with key development. Because the stream of numbers generated by a PRNG are not truly random, they are susceptible to cryptanalysis under certain circumstances. Furthermore, if the PRNG algorithm is publicly known, then the security of any encryption keys based on the generated stream of numbers depends largely upon the security of the initial state, or seed, of the PRNG.

The seed is a number used to initialize the PRNG process. The seed does not alter the stream of numbers produced. The seed merely changes the starting point within that stream of numbers, so knowledge of the PRNG and knowledge of the seed value would allow an attacker to predict the portion of the generated stream of numbers used to generate a particular encryption key. Even if the attacker does not know the exact portion of the generated stream of numbers used to generate the particular encryption key, it would greatly reduce the number of possibilities for a brute force attack. The seed can be recovered in various ways, ranging from recovering the seed value in the generated stream of numbers, to revelation of the seed value by a disgruntled former employee of the PRNG owner.

To guard against an attack based on knowledge of the seed value a PRNG must update its seed from time to time to maintain the security of the generated stream of numbers. A PRNG's seed can only be effectively updated by accumulating seed values (entropy) from a source known to be truly random. Entropy accumulation in this manner is an ongoing process for a secure PRNG. In the past, entropy has been accumulated in a variety of ways, including human user interaction with a computer keyboard (clock ticks between keyboard strokes and values assigned to the particular keystrokes), computer system performance parameters that are loading dependent, etc. Koopman, Jr., U.S. Pat. Nos. 5,696,828 and 5,757,923 disclosed a way to use sounds recorded and altered from an automobile cooling system as an entropy source for secret key generation.

Each of these sources of entropy suffers from various drawbacks and limitations. Keyboard strokes and computer performance parameters are not available in all circumstances in which encryption is desired. For example, neither of those sources for entropy is available in the wireless communications environment. In addition those sources are not truly random in all circumstances. Sound recorded from an automobile cooling fan is somewhat random but requires extensive manipulation of the recorded signal in order to ensure randomness and is not well suited for use in encryption key generation. Also, this source of entropy is not available in all circumstances in which encryption is desired because it can only be readily used when an automobile is connected to the device performing the encryption.

Other examples of entropy collection include nuclear processes that are not dependent upon external stimuli. For an example of this type of random number generation see Edelkind, et al., U.S. Pat. No. 5,987,483. Nuclear processes can provide both temporal randomness (the time between radioactive decays) and spatial randomness (the direction in which the product of the radio active decay is emitted). While nuclear processes can be truly random, they are not a very practical solution for most situations in which encryption is used and are especially ill-suited to mobile communications.

### SUMMARY OF THE INVENTION

A primary aspect of the present invention is to provide a system and method for secure communications in the mobile environment. Specifically, the system and method is for secure wireless communications in systems having an IMU, an electronic or mechanical device that measures the change in its own trajectory by measuring its own linear acceleration and angular rate, as part of a navigation system, such as a cellular phone with a Global Positioning System (GPS)/IMU-integrated navigation component, or an automobile with either an IMU or a GPS/IMU navigation system and a suitable wireless communications device. The system and method involves using measurement values output by the IMU for encryption key generation. IMUs when stationary are subject to random drift and noise. In addition, when the IMU is moving the drift and noise characteristics are modified by the actual details of the measured change in trajectory, which is itself random on a different level. Measurement values, or portions thereof; output from the IMU representing the drift; noise; and the measured change in trajectory of the IMU are then used to seed a PRNG that generates a stream of numbers, portions of which are suitable for use in encryption key generation. The encryption key is then exchanged between the intended parties, at which point encrypted messages can be sent back and forth between the parties.

Alternatively, the measurement values from the IMU, or portions thereof, can be used directly for encryption key generation, without the need for a PRNG, because the measurement values are, after all, a stream of random numbers. This approach reduces the necessary computer processing power by obviating the complex algorithms used in a PRNG while maintaining the overall security of the system.

Additional objects and advantages of this invention will be apparent from the following detailed description of preferred embodiments thereof, which proceeds with reference to the accompanying drawings.

### BRIEF DESCRIPTION OF THE DRAWINGS

FIG. 1 is a simplified block diagram of the components of a mobile unit that comprises an inertial measurement unit, a computing platform, and a wireless communication device.

FIG. 2 is a more detailed block diagram of principle software layers of the computing platform in FIG. 1.

FIG. 3 is a flow chart depicting a method for generating random numbers for use in encryption key generation utilizing a PRNG seeded with selected measurement values from an IMU in accordance with the present invention.

FIG. 4 is a flow chart depicting a method of secure communication using a PRNG, seeded with measurement values from an IMU, to generate a stream of numbers for use in encryption key generation in accordance with the present invention.

FIG. 5 is a flow chart depicting a method for using selected portions of an IMU's measurement values in conjunction with an encryption program to generate encryption keys in accordance with the present invention.

FIG. 6 is a flow chart depicting a method of secure communication using selected portions of collected measurement values from an IMU in conjunction with an encryption program to generate an encryption key in accordance with the present invention.

FIG. 7 is a block diagram of the components of a wireless telephone handset including the mobile unit as shown in FIGS. 1 and 2, a wireless telephone handset is only one example of a device containing the mobile unit that could be included in any device ranging from a personal digital assistant to a vehicle.

### DETAILED DESCRIPTION OF PREFERRED EMBODIMENT

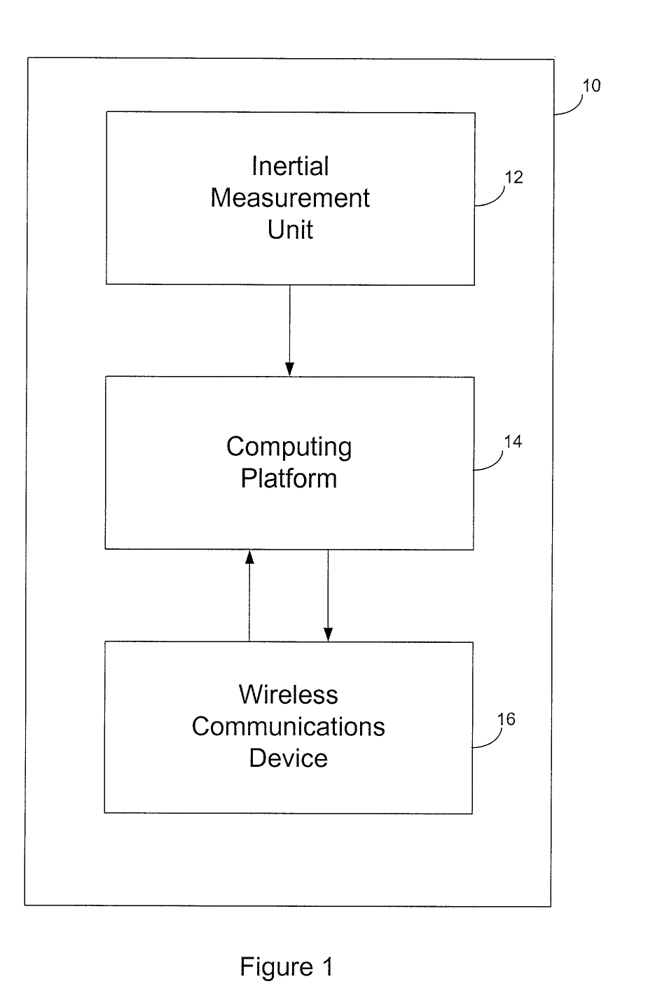

FIG. 1 depicts a mobile unit 10 according to the present invention. In reference to FIG. 1, mobile unit 10 comprises an inertial measurement unit (IMU) 12, a computing platform 14, and a wireless communication device 16. IMU 12 communicates with computing platform 14 such that messages can at least be sent from IMU 12 to computing platform 14. Computing platform 14 communicates with wireless communication device 16 such that messages can be sent back and forth between computing platform 14 and wireless communication device 16.

IMU 12 measures changes in its own trajectory by measuring its own linear acceleration, or its own angular rate, or some combination of its linear acceleration and angular rate. Typically, this is also the change in trajectory of something IMU 12 is physically attached to, such as mobile unit 10. Typically, IMU 12 measures linear acceleration with up to three linear accelerometers. Angular rate is typically measured with up to three gyros. IMU 12 measures its linear acceleration and angular rate in at least one dimension (degree of freedom) and in up to as many as six degrees of freedom. IMU 12 forms new measurement values for each degree of freedom at a predetermined frequency. In accordance with the present invention, IMU 12 communicates the measurement values to computing platform 14.

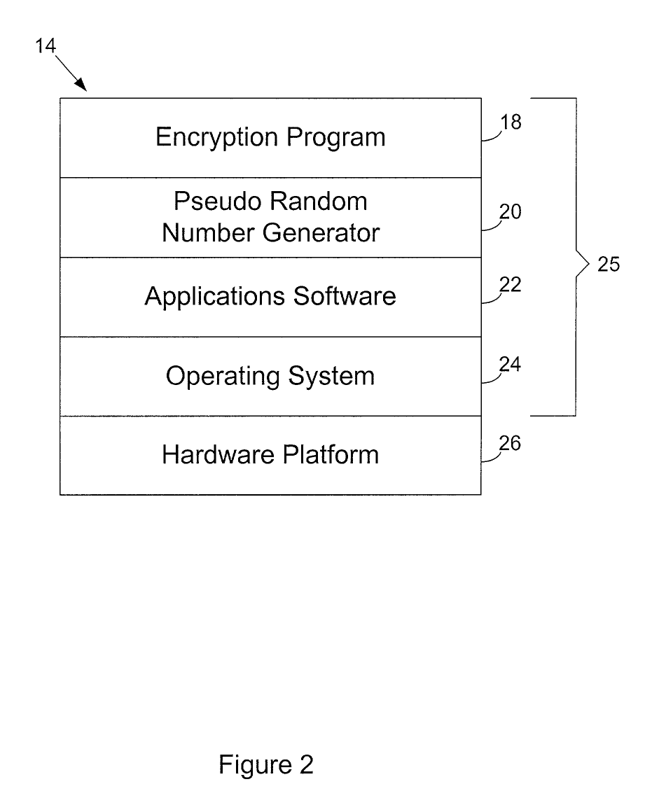

FIG. 2 is a more detailed block diagram of computing platform 14. In reference to FIG. 2, computing platform 14 comprises a hardware platform 26 and a memory 25. Stored in memory 25 are the following: an operating system 24, appropriate for particular hardware platform 26; applications software 22, for selecting a portion of the measurement values communicated to computing platform 14 any other functions to be performed by computing platform 14; a pseudo random number generator (PRNG) 20; and an encryption program 18. Memory 25 is sufficiently large to store the above as well as the measurement values received from IMU 12 and communications received from wireless communication device 16. Memory 25 is composed of nonvolatile memory, volatile memory, or preferably a combination of the two.

In accordance with the present invention, PRNG 20 can be any of a wide variety of cryptographic strength PRNGs. For example, PRNG 20 could be any of the following: ANSI X9.17 PRNG, RSAREF 2.0 PRNG, DSA PRNG, Yarrow, a proprietary Linear Congruential Generator, etc. Any PRNG whose seed can be updated from time to time is a satisfactory PRNG 20 in accordance with the present invention.

In accordance with the present invention, encryption program 18 consists of any cryptographic protocol, or any combination of cryptographic protocols, the overall security of which depends, at least in part, on random numbers for encryption key generation such as the following: RSA, described in U.S. Pat. Nos. 4,405,829; DES, described in 3,962,539; DSA, described in 5,231,668 and 4,995,082; Twofish; SHA-1; elliptical curve encryption programs; a Feistel Network Cipher; or Cipher block chaining (CBC) with or without the use of an initialization vector. In the case in which encryption program 18 is some form of block cipher using CBC it may be necessary ensure that all cipher blocks are the same size by using a form of cipher block padding, such as the RSA standard PKCS #5 or PKCS #7. The above patents describing particular encryption protocols are hereby incorporated by reference. Alternatively, encryption program 18 could consist of a proprietary combination of encryption primitives such as the following: hash functions; elliptic curve math functions; big number math functions; digital signature schemes; bit commitment protocols; block ciphers; PRNGs; key agreement schemes; message authentication codes; prime number generators; etc. Selection of a particular encryption program 18 is just a design choice influenced by a variety of factors including the level of security desired, the amount of processing power available in computing platform 14, memory 25 available in computing platform 14, and acceptable time delay caused by encrypting and decrypting messages.

IMU 12 is typically subject to drift, noise, and bias characteristics that are normally distributed. These random characteristics are problematic for inertial navigation and much work has gone into eliminating or accounting for those inherent inaccuracies. Those same undesirable random characteristics, however, make IMU 12 a good source of seed values (entropy) for PRNG 20 in accordance with the present invention. When mobile unit 10 is in motion, IMU 12 forms measurement values that represent a combination of the actual change in trajectory of mobile unit 10, the earth's rotation rate and gravitational forces at the location of mobile unit 10, and the normally distributed drift, bias, and noise characteristics of IMU 12. All aspects of the formed measurement values are random to a certain degree. The change in trajectory of mobile unit 10 depends on such unpredictable factors as the route of an automobile or the movement of a wireless telephone handset 28, which mobile unit 10 is attached to. In addition, the measurement value depends on the actual location of mobile unit 10, due to the earth's varying gravity and rotation rate. Finally, the measurement value includes the random drift, noise, and bias characteristics inherent in IMU 12. To ensure even greater entropy PRNG 20 can be seeded based on only the three least significant bits of any of the measurement values. These bits will be the least accurate bits in a measurement value and as such will be the most unpredictable to an attacker.

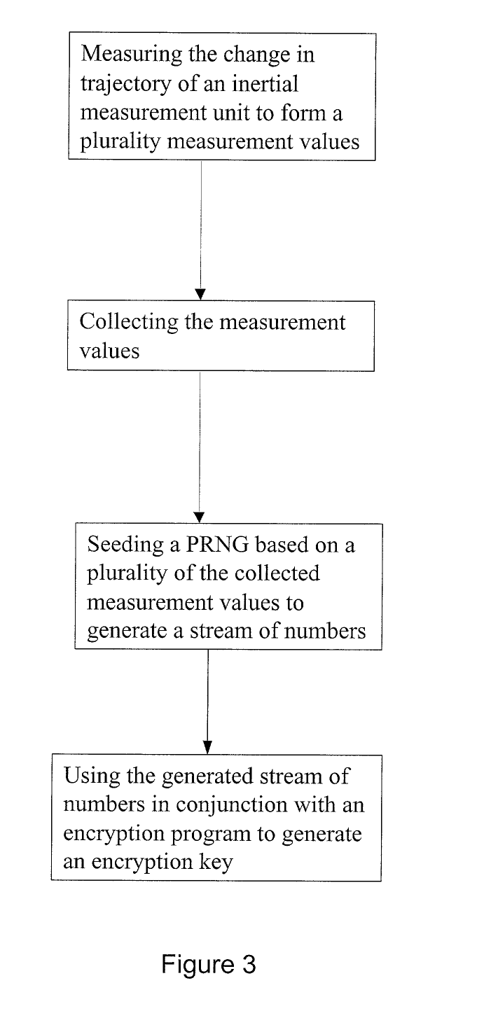

FIG. 3 is a flow chart depicting a method for generating a stream of numbers for use in encryption key generation utilizing PRNG 20 in accordance with the present invention. In reference to FIG. 3, IMU 12 measures its change in trajectory to form measurement values. The measurement values are then collected and stored in memory 25. PRNG 20 is then seeded based on a plurality of the collected stored measurement values in order to generate a stream of numbers. The generated stream of numbers is then used in conjunction with encryption program 18 for generating an encryption key.

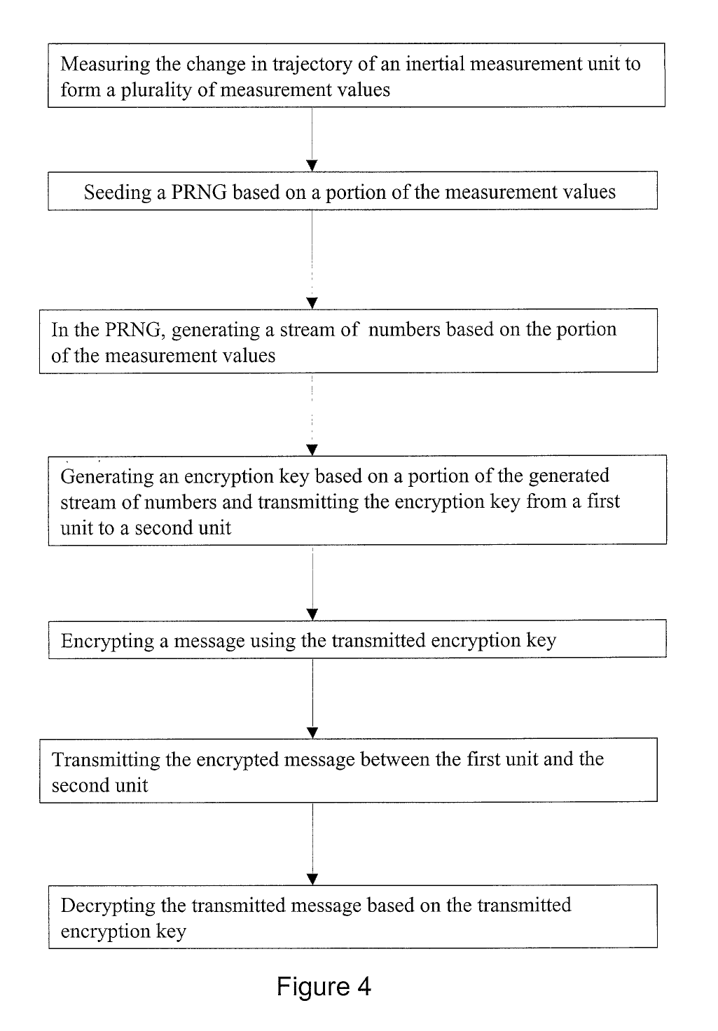

FIG. 4 is a flow chart depicting a method of secure communication using PRNG 20, seeded with measurement values from IMU 12, to generate a stream of numbers for use with encryption program 18 for encryption key generation in accordance with the present invention. In reference to FIG. 4, the method begins by measuring the change in trajectory of IMU 12 to form a plurality of measurement values. Next, PRNG 20 is seeded based on a portion of the plurality of measurement values. PRNG 20 generates a stream of numbers based on the portion of the plurality of measurement values. Encryption program 18 then uses a portion of the generated stream of numbers to generate an encryption key, which is then transmitted from a first unit to a second unit. The first unit includes mobile unit 10. The second unit may or may not include mobile unit 10. Either the first unit or the second unit encrypts a message using computing platform 14, or the second unit's computing platform, encryption program 18 and the transmitted encryption key or, in the case of public key encryption, an encryption key that is mathematically related to the transmitted encryption key. The unit that performed the encryption then transmits the encrypted message to the other unit, so that if the first unit encrypted the message then the first unit transmits the message to the second unit and vice versa. The recipient of the message then decrypts the message using computing platform 14, or the second unit's computing platform, and encryption program 18 based on the transmitted encryption key.

In accordance with the present invention, encryption key exchange, i.e., transmitting the encryption key from the first unit to the second unit, can be accomplished using a variety of methods. When encryption program 18 is a public key encryption protocol, the mobile unit 10 and the intended recipient can simply transmit their respective public keys to each other prior to transmitting an encrypted message. When encryption program 18 is a private key encryption protocol, several options are available. One option would be for the mobile unit 10 to encrypt the generated encryption key using a public key encryption protocol as discussed above and transmit the encrypted generated encryption key to the second unit. Specifically, mobile unit 10 will encrypt the generated private encryption key with the second unit's asymmetric public key and transmit the encrypted generated private encryption key to the second unit. The second unit then uses its private asymmetric key to decrypt the generated private encryption key. Both units are now in possession of the generated encryption key, and either unit can encrypt messages with the generated private encryption key and transmit the encrypted messages. Another option is for mobile unit 10 and the second unit to create a shared private encryption key. In this scenario, mobile unit 10 transmits a portion of the generated stream of numbers, or a stream of numbers based on a portion of the generated stream of numbers, to the second unit. The second unit likewise transmits a stream of numbers to mobile unit 10. Then, both mobile unit 10 and the second unit generate a private encryption key known to both units based on the stream of numbers transmitted by mobile unit 10 and the second unit, respectively, using a known key exchange protocol, such as Diffic-Hellman key exchange protocol, or Station-to-Station key agreement protocol.

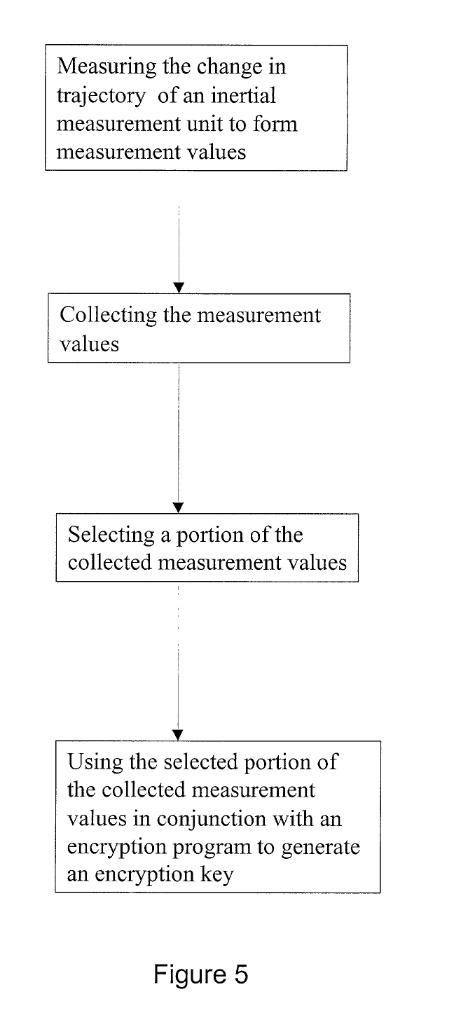

FIG. 5 is a flow chart depicting a method for generating encryption keys without the need for PRNG 20. In reference to FIG. 5, the first step in the method is to measure the change in trajectory of IMU 12 to form a plurality of measurement values. The next step is collecting the measurement values from IMU 20, for example into memory 25. Computing platform 14 and application software 22 then select a portion of the collected measurement values, and computing platform 14 uses that selected portion of the collected measurement values in conjunction with encryption program 18 to generate an encryption key.

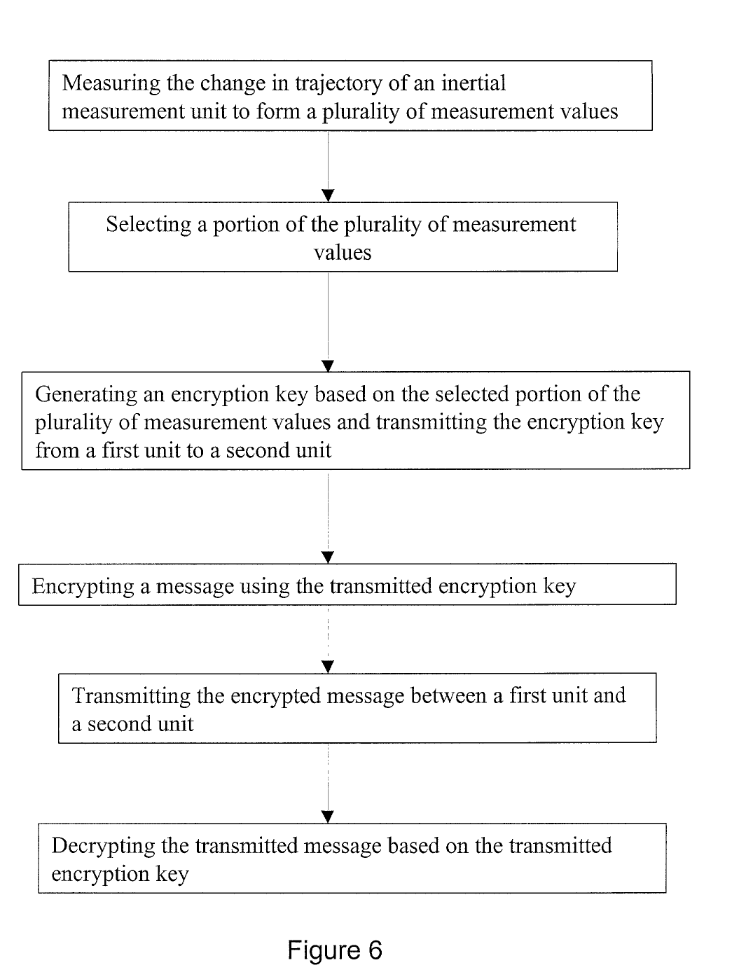

FIG. 6 depicts a flow chart of an alternative method for secure communication using a portion of measurement values from IMU 12 in conjunction with encryption program 18 to generate an encryption key. In reference to FIG. 6, IMU 12 measures the change in trajectory of mobile unit 10 to form a plurality of measurement values representing a combination of the actual change in trajectory of mobile unit 10, earth rate and gravitational forces at the location of mobile unit 10, and the normally distributed drift, bias, and noise characteristics of IMU 12. Application software 22 then selects a portion of the plurality of measurement values. Encryption program 18 then uses the selected portion of the plurality of measurement values to generate an encryption key that wireless communication device 16 then transmits from a first unit, which includes mobile unit 10, to a second unit, which may or may not include mobile unit 10. Then computing platform 14, or the second unit's corresponding computing platform, uses encryption program 18 to encrypt a message based on the transmitted encryption key. The unit that performed the encryption then transits the encrypted message to the other unit, so that if the first unit encrypted the message then the message is transmitted from the first unit to the second unit and vice versa. The recipient of the message then decrypts the message with computing platform 14 and encryption program 18 based on the transmitted encryption key. If encryption program 18 is a symmetric encryption program, then the transmitted encryption key is used as the decryption key. If encryption program 18 is an asymmetric encryption program, then a second key, mathematically related to the transmitted encryption key, is used as the decryption key.

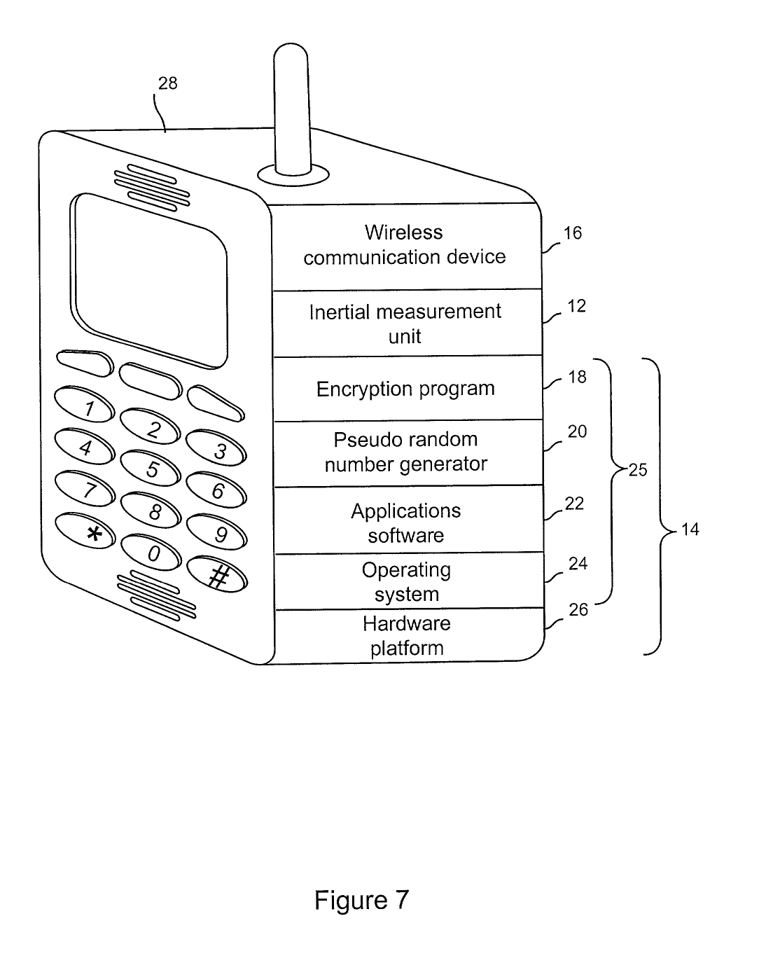

FIG. 7 depicts a preferred embodiment of mobile unit 10. In reference to FIG. 7, wireless telephone handset 28 includes mobile unit 10. As discussed above, mobile unit 10 includes IMU 12, wireless communication device 16, and computing platform 14. IMU 12, wireless communication device 16, and computing platform 14 communicate with each other as described in reference to FIGS. 1 and 2. Encryption program 18 can be any encryption program as described above, although preferably encryption program 18 is a symmetric encryption program due to limited processing power currently available for computing platform 14 for use in wireless telephone handset 28 and also due to a desire for minimal time delay due to encryption and decryption. PRNG 20 is any PRNG, as described above, whose seed can be updated from time to time.

In a preferred embodiment of the claimed invention, wireless telephone handset 28 is a cellular telephone with appropriate wireless communication device 16 to operate with a cellular network for placing and receiving telephone calls. Operating system 24 could be any of a number of suitable operating systems. For example, operating system 24 could be any of the following: EPOC®, Palm OS®, Windows CE®, etc.

In accordance with the present invention, applications software 22 includes a selection program for selecting measurement values for use in seeding PRNG 20 or alternatively for use in conjunction with encryption program 18 to generate an encryption key. Suitable selection programs could include a method for selecting a single measurement value from each set of sequential measurement values, such as when IMU 12 measures its change in trajectory at periodic intervals to form sequential sets of measurement values. One suitable selection program involves selecting a trigger element from each set of sequential measurement values and determining which measurement value will be selected from that set of sequential measurement values based on the value of a selected portion of the trigger element. In this selection program the trigger element for all sets of sequential measurement values, except the first set, is the measurement value corresponding to the selected measurement value from the previous set of sequential measurement values. The trigger element for the first set of sequential measurement values can be any arbitrarily selected measurement value from that set. The selected portion of the trigger element is any arbitrarily selected bit field of the trigger element, although the three least significant bits of the trigger element will be the least accurate bits and therefore the most unpredictable to an attacker. Additionally, a selection program can be composed for selecting measurement values from arbitrarily selected sets of sequential measurement values based on the value of a selected portion of the selected measurement value from the previous set of sequential measurement values.

A specific example of a selection scheme as described above involves mobile unit 10 including IMU 12, which in this example has six degrees of freedom. The selected bit field of the trigger element will represent a number from zero to seven. If the bit field value is zero then the selected measurement value for that set of sequential measurement values is the trigger element. If the bit field value is seven, then the selected measurement value for that set of sequential measurement values is the selected measurement value from the previous set of sequential measurement values or some other arbitrarily chosen measurement value. If the bit field value is one to six, then a corresponding one of the six measurement values is the selected measurement value for that set of sequential measurement values. As discussed above, the trigger element for the first set of sequential measurement values is any arbitrarily selected measurement value and the trigger element for each set of sequential measurement values, except the first set of sequential measurement values, is the selected measurement value from the previous set of sequential measurement values.

It will be obvious to those having skill in the art that many changes may be made to the details of the above-described embodiment of this invention without departing from the underlying principles thereof. The scope of the present invention should, therefore, be determined only by the following claims.

1. A method for generating random numbers for use in secure communications comprising:
providing an inertial measurement unit;
measuring the change in trajectory of the inertial measurement unit to form a measurement value;
forming a seed value based on the measurement values;
seeding a pseudo random number generator with the seed value;
activating the pseudo random number generator to generate a stream of numbers in response to the seed value; and
using a portion of the generated stream of numbers in conjunction with an encryption program to generate an encryption key.

2. The method of claim 1 further comprising the step of repeating the measuring, forming, seeding, activating, and using steps of claim 1 at predetermined time intervals.

3. A method for generating random numbers for use in secure mobile communications comprising:
measuring the change in trajectory of an inertial measurement unit to form a measurement value;
storing the measurement value;
selecting a portion of the stored measurement value;
seeding a pseudo random number generator based on the selected portion of the stored measurement value;
generating a stream of numbers with the pseudo random number generator based on the selected portion of the stored measurement value; and
using a portion of the generated stream of numbers along with an encryption program to encrypt a message.

4. A method for secure communication without a pseudo random number generator comprising:
measuring the change in trajectory of an inertial measurement unit to form a plurality of measurement values;
sampling one or more of the plurality of measurement values;
selecting a portion of the sampled measurement values; and
using the selected portion of the sampled measurement values in conjunction with an encryption program to generate an encryption key, thereby obviating the complex algorithms used in a pseudo random number generator while maintaining the overall security of the system.

5. The method of claim 4 in which the selected portion of the sampled measurement values comprises an arbitrary bit field of a predetermined number of measurement values.

6. The method of claim 5 in which the arbitrary bit field comprises the three least significant bits of each of the predetermined number of measurement values.

7. A system for secure communication comprising:
an inertial measurement unit with a measurement output, for outputting measurement values;
a computing platform, connected to the inertial measurement unit to receive and store the measurement values output by the inertial measurement unit; and
a pseudo random number generator program, for generating a stream of numbers based on the received measurement values.

8. The system of claim 7 further comprising:
an encryption program for encrypting data based on the generated stream of numbers; and
a wireless communications device, connected to the computing platform and capable of transmitting the encrypted data and an encryption key based on the generated stream of numbers.

9. A system for secure communication without a pseudo random number generator for encryption key generation comprising:
an inertial measurement unit with a measurement output, capable of outputting measurement values;
a computing platform, connected to the inertial measurement unit to receive and store measurement values output by the inertial measurement unit; and
an encryption program, for encrypting data based on a selected portion of the received measurement values.

10. A system according to claim 9 further comprising a wireless communication device, connected to the computing platform and capable of transmitting an encrypted message and an encryption key based on the selected portion of the received measurement values.

11. A method for secure data transmission comprising:
measuring the change in trajectory of an inertial measurement unit to form a plurality of measurement values;
seeding a pseudo random number generator based on a portion of the plurality of measurement values;
in the pseudo random number generator, generating a stream of numbers based on the portion of the plurality of measurement values;
generating an encryption key based on the generated stream of numbers;
transmitting the encryption key from a first unit to a second unit;
encrypting a message with the transmitted encryption key; and
transmitting the encrypted message between the first unit and the second unit.

12. The method of claim 11 in which the movement of the inertial measurement unit is measured at periodic intervals to form a series of sequential measurement values.

13. The method of claim 12, further comprising:
selecting a plurality of the sequential measurement values; and
generating a stream of numbers with the pseudo random number generator based on the selected sequential measurement values.

14. The method of claim 13 in which the selection of the plurality of the sequential measurement values includes:
selecting a trigger element for each set of sequential measurement values; and
determining which measurement value will be selected from that set of sequential measurement values based on the value of a selected portion of the trigger element.

15. The method of claim 14 in which the trigger element for a set of sequential measurement values comprises the selected measurement value from the previous set of sequential measurement values.

16. The method of claim 15 in which the selected portion of the trigger element comprises the three least significant bits of the trigger element.

17. The method of claim 11 in which the random number is transmitted from the first unit to the second unit by a wireless communication device.

18. A method for generating encryption keys, comprising:
measuring the change in trajectory of a wireless telephone handset to produce a plurality of measurement values;
selecting a portion of the plurality of measurement values;
seeding a pseudo random number generator with the selected portion of the plurality of measurement values to generate a stream of numbers; and
generating an encryption key based on a portion of the stream of numbers.

19. A method for secure wireless communication, comprising:
measuring the change in trajectory of a mobile unit to produce a plurality of measurement values;
selecting a portion of the plurality of measurement values;
seeding a pseudo random number generator with the selected portion of the plurality of measurement values to generate a stream of numbers;
selecting a portion of the generated stream of numbers for use in encryption key generating;
generating an encryption key based on the selected portion of the generated stream of numbers;
transmitting the generated encryption key from the wireless communication device to an intended recipient; and
encrypting a message based on the transmitted encryption key.

20. The method of claim 19, further comprising:
transmitting the encrypted message between the wireless communication device and the intended recipient; and
decrypting the transmitted message based on the transmitted encryption key.
